(19) United States
(12) Patent Application Publication
(10) Pub. No.: US 2010/0235078 A1
(43) Pub. Date: Sep. 16, 2010

(54) DRIVING DIRECTIONS WITH MAPS AND VIDEOS

(75) Inventors: Billy Chen, Bellevue, WA (US); Michael F. Cohen, Seattle, WA (US); Eyal Ofek, Redmond, WA (US); Boris Neubert, Baden-Wuerttemberg (DE)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/403,239

(22) Filed: Mar. 12, 2009

(51) Int. Cl. G01C 21/26

(52) U.S. Cl. 701/200

(57) ABSTRACT

The illustration may have a separate display window that displays illustrations which may be moving illustration related to the current spot on the map or to future spots on the map. The illustration may be viewed while traveling or may be viewed in advance. The moving illustration may display segments of the travel path with points of interest and substantial changes at a slow speed and/or low altitude and may display segments without points of interest and/or few substantial changes at a high speed and or high altitude.

### BACKGROUND

This Background is intended to provide the basic context of this patent application and it is not intended to describe a specific problem to be solved.

Navigational displays are useful tools. Illustrations of maps which map a current location or provide directions from a first point to a second point are useful. However, points of interest may be missed or not appreciated. Trying to illustrate proper lanes or turning locations also is difficult. In real life, people often use landmarks to assist in navigation but illustrating landmarks on a navigational map is difficult. Further, once a user has traveled a path, subsequent trips on the path are significantly easier but trying to illustrate a trip on a map without being boring and as long as the trip itself is a challenge.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method to create a navigational illustration is described. The illustration may have a separate display window that displays additional illustrations which may be moving illustrations related to the current spot on the map or to future spots on the map. The illustration may be viewed while traveling or may be viewed in advance. The additional illustration may display segments of the travel path with points of interest and substantial changes in the path at a slow speed and/or low altitude and may display segments without points of interest and/or few substantial changes in the path at a high speed and or high altitude. The moving illustration may be in a separate window that moves away from the navigational illustration to highlight upcoming points of interest or substantial changes.

### BRIEF DESCRIPTION OF THE DRAWINGS

FIG. 1 is an illustration of a portable computing device;

FIG. 2 is an illustration of a method of creating a navigation illustration with additional detail;

FIG. 3 is an illustration of a map with an additional window to display additional information about the map;

FIG. 4 is an illustration a moving display with various points of interest;

FIG. 4 is an illustration of a map with a fly-out display of additional information about the map;

FIG. 5 is an illustration of a view authoring tool.

FIG. 6 is an illustration with an additional window to display additional information about the map and additional text related to the navigation;

FIG. 7 is an illustration of a map with a fly-out display of additional scenes of interest at a different elevation and displayed at a different speed;

FIG. 8 is an illustration of a map with a fly-out display of additional scenes of interest; and

FIG. 9 is an illustration of a method of displaying a navigation illustration with additional detail.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

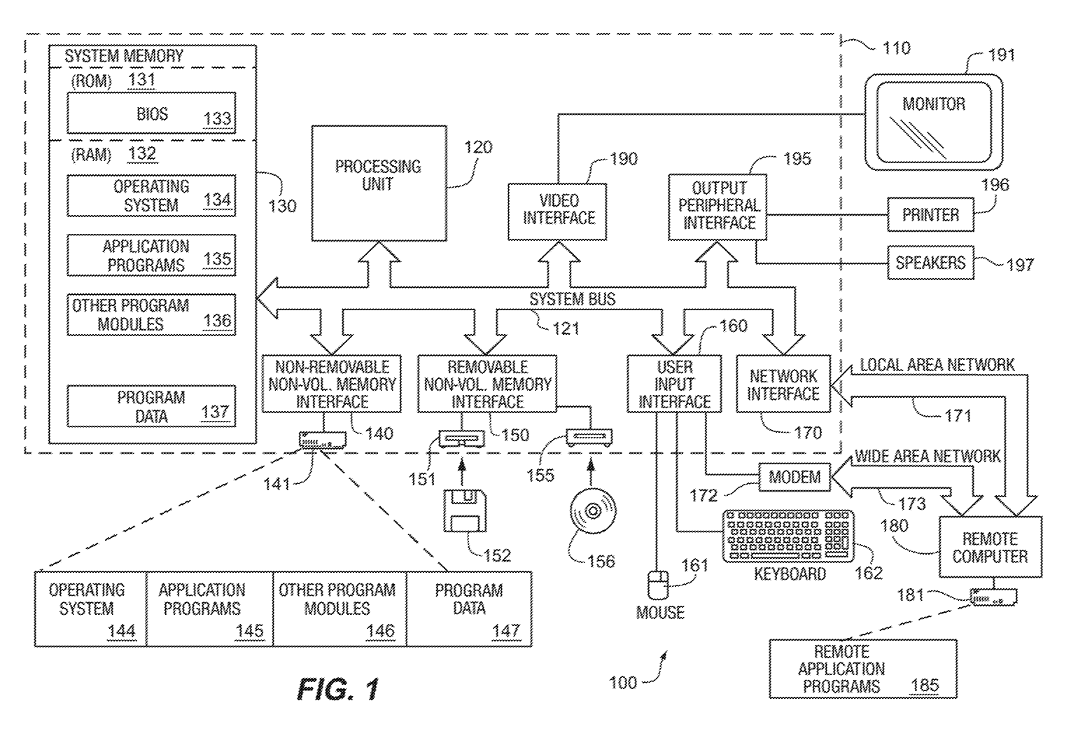

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

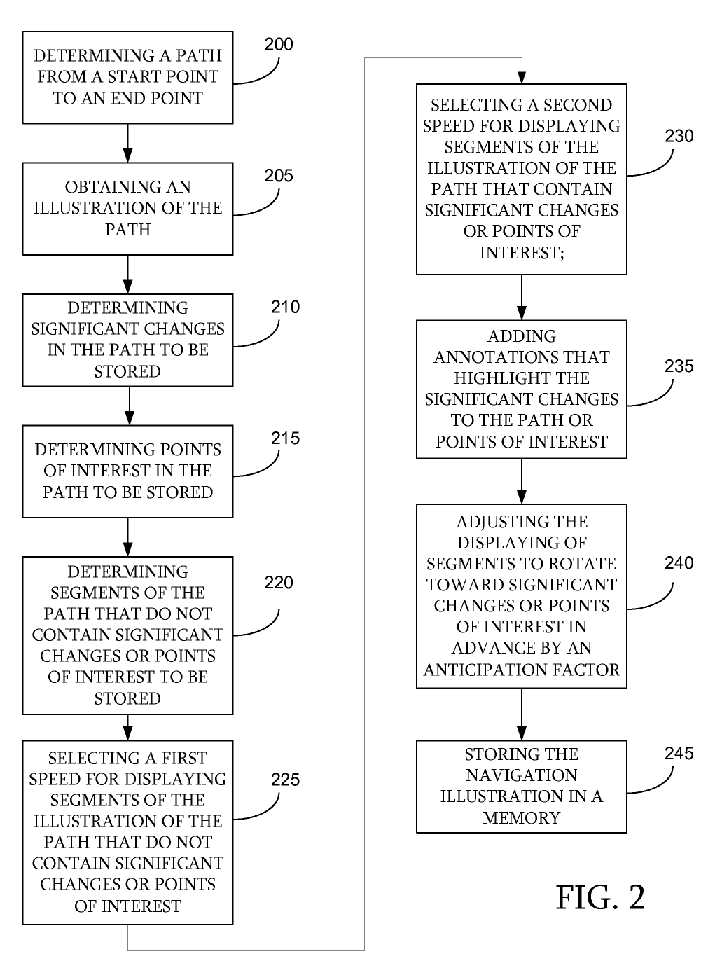

FIG. 2 illustrates a method of creating a navigation illustration. The navigation illustration 300 may have a standard navigational map 305 and a separate display window 310 that may display an additional illustration 315 of navigational directions. The additional illustration 315 may be a variety of media that may be displayed in a variety of ways. In one example, the separate display window 310 may display a video as the additional illustration 315, taken from a driver's perspective of the road ahead. The additional illustration 315 video may proceed slowly or at a low altitude during turns or near points of interest of may proceed quickly or at a high altitude during paths of little interest. The additional illustration 315 video may also “fly-out” or be removed from the navigational map 305 and be displayed separately in its own window.

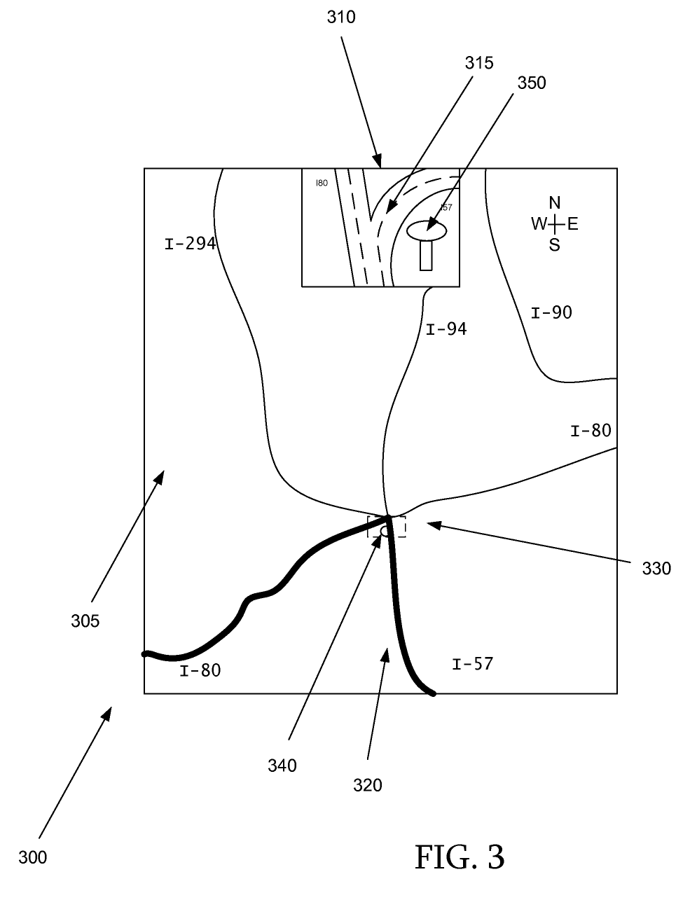

At block 200, a path 320 (bold in FIG. 3) may be determined from a start point to an end point. The start point and end point may be entered by a user or by another application. In another embodiment, the start point is a current location of a vehicle, a person, a train, an airplane, etc. The path 320 may be a road, a shipping lane, an airline path, a railroad track, a hiking trail, a ski trail, a path through a hospital, a path 320 through a parking garage to your car, through an amusement park, through an office building, convention center or office complex, etc. The path 320 may even be in a video game where the path 320 leads through a virtual world. The variety of types of paths 320 is only limited by the imagination. The determination of the path is completed using any of the many mapping applications available such as Microsoft® Virtual Earth™, Google maps, etc.

At block 205, the additional illustration 315 of the path 320 is obtained. The additional illustration 315 may be a 360 degree panorama view of the path 320. The additional illustration 315 may be a video, a plurality of videos, an illustration, or any other useful and appropriate way to visualize the path 320.

At block 210, if there are any significant changes 330 in the path 320, these changes are determined and stored. Significant changes 330 may include turns, merges, lane changes, trail crossings, railroad crossings and dangerous intersections, etc. A significant change 330 is a change in the road that may require the person in control to take notice, such as turn, avoid merging cars, look for a landmark, etc. Element 330 may be an example of a significant change, where a drive has to merge from I-80 east to I-57 south. The significant changes 330 in the path 320 may be used to create separately displayed windows or to create annotations to not the significant changes 330.

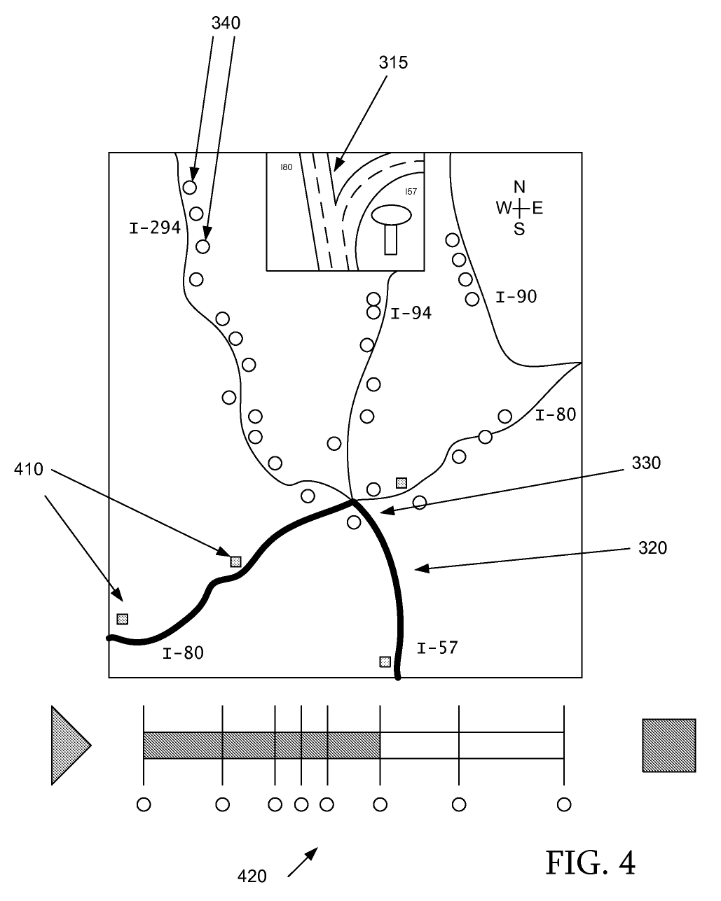

At block 215, points of interest 340 in the path 320 may be determined and stored. Points of interest 340 may be areas that are deserving to most people of a closer look. Example of points of interests 340 include restaurants, gas stations, shopping locations, geographic formations, scenic vistas, billboards, signs and interchanges, etc. The points of interests 340 may be separated into categories and all the points of interest 340 in a particular category may be displayed. For example, a user may love to play golf and the points of interest 340 may relate to golf courses that can be seen. As an example, in FIG. 4, all the gas stations may be marked with a circle as being points of interest 340.

Referring briefly to FIG. 4, periodic checkpoints 410 (squares in the drawing) may be added to the path 320. The periodic check points 410 may be used when there are no relevant points of interest 340 but a user may still want to know whether they are on the correct path 320. Periodic checkpoints 410 remind a driver that they are on the correct path 320.

At block 220, segments of the path 320 that do not contain significant changes 330 or points of interest 320 to be stored may be determined. For example in FIG. 4, I-57 south of I-80 may be flat, relatively straight and be surrounded by cornfields. To most people, cornfields are not points of interest 340 and the gradual curve would not qualify as a significant change 330. In the alternative, I-294 has a significant number of points of interest 340 and would not be stored as a segment of the path 320 that does not contain significant changes 330 or points of interest 320.

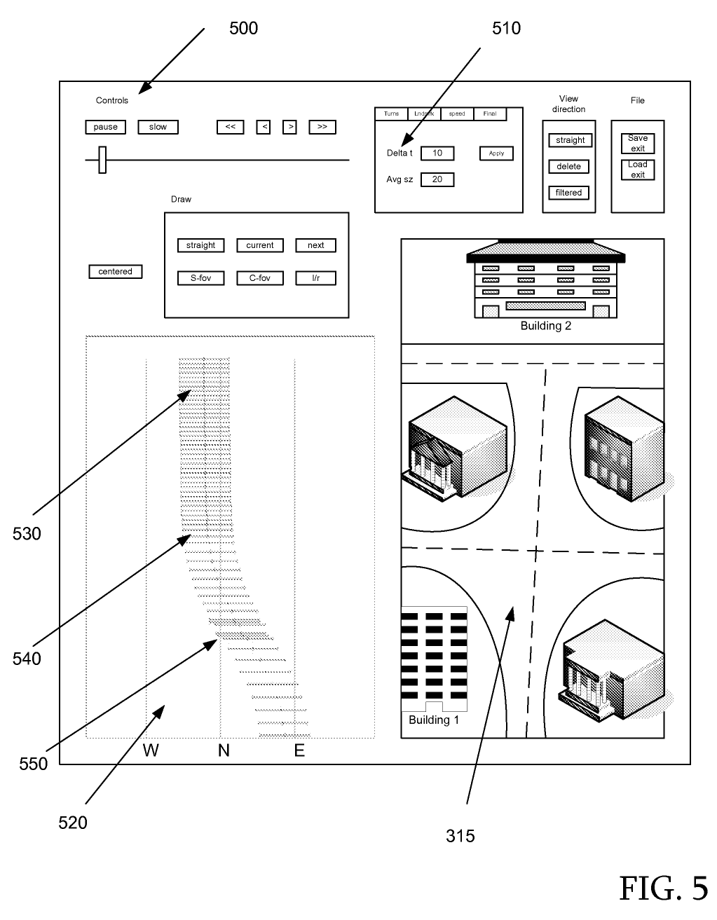

At block 225, a first speed for displaying segments of the illustration of the path 320 that do not contain significant changes 330 or points of interest 340 may be selected. FIG. 5 is an illustration of an interface for creating a moving illustration 315 to be displayed in the separate window 310. Depending on the position in the moving illustration 315, there may be a desire for the speed to be high through area without significant changes 330 or points of interest 340 as there is little to see. It may make little sense to slowly illustrate yet another corn field passing by.

The user also may select significant changes 330 or points of interest 340 to be displayed in a separate window 310. For example, if a user is preview a path 320 of a trip, significant changes 330 and points of interest 340 may be noted on the path. The significant changes 330 and points of interest 340 may be selected and then additional detail about the significant changes 330 and points of interest 340 may be displayed in the separate window 310.

In another embodiment, the altitude of the view of the path 320 may also be adjusted higher if the path 320 is passing through an area without significant changes 330 to the path or points of interest 340. As there are few details to see, a higher altitude is sufficient to inform the user of the path 320.

At block 230, a second speed for displaying segments of the illustration of the path 320 may be selected that contains significant changes 330 or points of interest 340. FIG. 5 is an illustration of an interface for creating a moving illustration 315 to be displayed in the separate window 310. Depending on the position in the additional illustration 315, there may be a desire for the speed to be high through an area without significant changes 330 or points of interest 340 as there is little to see. At the same time, if there are significant changes 330 or points of interest 340, the moving illustration may proceed slower. Significant changes 330 such as turns would be driven slower in real life, so it makes sense to illustrate turns at a lower speed. For example, referring to FIG. 3, when turning from I-80 east to I-57 south, a water tower 350 may be a point of interest 340 that signifies to a driver that they should be in the right lanes in order to merge onto I-57 south. Referring to FIG. 5, controls 500 may be used to adjust the speed of the illustration 315.

In some embodiments. the zoom or altitude of the map may be proportional to the speed such that the visible screen speed may remain constant. Accordingly, the speed on the screen may appear constant but the amount of distance traveled may vary depending on the zoom or altitude. For example, traveling through rural areas may be at a high altitude or minimum zoom and a large distance may be traversed as the display moves at a constant speed while driving through a city may be at a low altitude or maximum zoom and a small distance may be covered while the display moves at the same speed. Of course, other embodiments are possible and are contemplated, such as having the speed of the display being proportional to the speed limit, etc.

In another embodiment, the altitude of the view of the path 320 may also be adjusted lower if the path 320 is passing through an area with significant changes 330 or points of interest 340. Altitude may be thought of as a height or zoom of the view. Referring to FIG. 3, the additional illustration 315 may be at a lower altitude than the navigational map 305. The navigational map 305 may be at the lower altitude. As there are key details to see, such as a building right before a turn need to be made, a lower altitude may be useful to inform the user of the path 320. For example, the darkened path 320 of I-80 east may be flat and without significant changes 330 or points of interest 320. Accordingly, this section of the path 320 may be illustrated at a high altitude. However, once the path approaches the I-57 exchange, the water tower 350 may be a point of interest 340 and the exit on to I-57 may be a significant change 330. Accordingly, the altitude may be lower to highlight the water tower 350 and the turn required to merge onto I-57. Once on I-57, the altitude may be higher as there may be no significant changes 330 or points of interest 340.

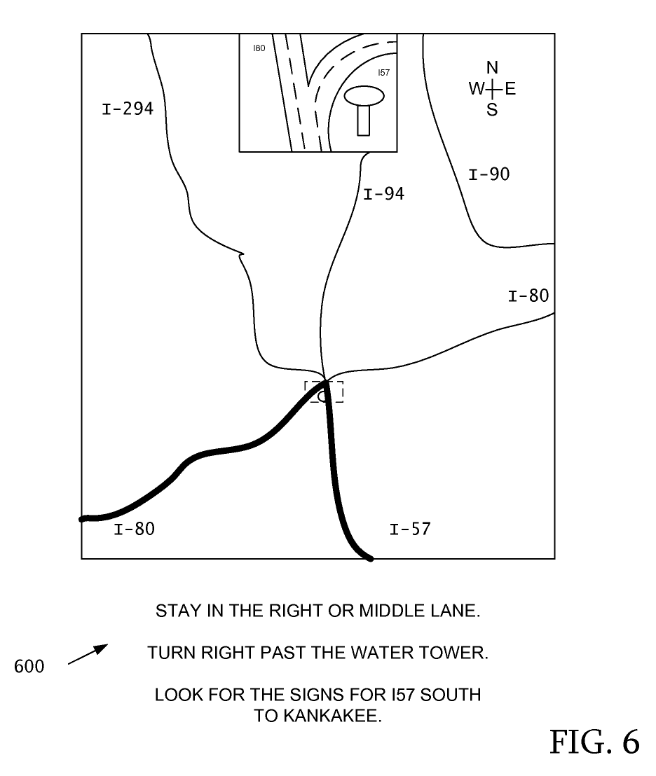

At block 235, annotations 600 (FIG. 6) may be added to highlight the significant changes 330 to the path 320 or points of interest 340 on the path 320 in the moving illustration 315. The annotations 600 may provide directions related to following the significant changes 330 in the path 320. The annotations 600 also may describe points of interest 340. In addition, the annotations 600 may describe virtually anything related to the map, the moving illustration 315 or a category of information, such as “Steve McQueen once filmed a movie in Kankakee.” The annotations 600 may be text, graphics such as arrows pointing out a turn, voices to announce a turn, etc.

At block 240, the display of segments in the addition illustration 315 may be adjusted toward significant changes 330 or points of interest 340 in advance by an anticipation factor 510. The adjustment may be to rotate or expand the field of view toward the significant changes 330 or points of interest 340. The view diagram 520 may provide one way of rotating the view toward significant changes 330 or points of interest 340 in advance of passing the significant changes 330 or points of interest 340. Assuming that the additional illustration 315 has a 360 degree view. While approaching a turn from point 530, the interval between the display frames is small, indicating that the speed of the moving illustration 315 is slow. The center hash mark may indicate the direction of car travel. As the car approaches a turn to the east, the view, as indicated by the horizontal lines 540, turns more and more east in anticipation of the turn to the east. In this way, a driver can look in the direction of the turn before the turn is upon them. As the car travels east, the horizontal line indicates the view is looking east. The same pattern may be followed for points of interest 340 where the view may turn toward point of interest 340 as the driver passes by.

The view can also be expanded (as opposed to directed or rotated) toward the significant changes 330 or points of interest 340. In this case, the view remains perspective in the center, but smoothly transitions to a cylindrical (straight lines are no longer straight) view. The purpose of the cylindrical projection on the periphery is to extend the potential field of view beyond 180 degrees.

In some situations, the moving illustration will have to switch from a first file to a second file to create the additional illustration 315, such as when a driver moves from a first street and turns onto a second street. The additional illustration 315 of the paths 320 may be taken from a camera that travels down one street and then down the next. It would be rare that the camera would follow the exact path required for route guidance. Accordingly, two separate illustrations may need to be combined to create a smooth additional illustration 315 of the path 320 from a first stored illustration to a second stored illustration.

In such cases where a first store image and a second stored image need to be merged, the view of the first stored image may be directed toward the direction of the second store image that will be used. At the same time, in the background, the second image may be directed toward where the first stored image is coming from. At some point, the two images will be of the same scene such as where the two streets intersect. This is because both images are 360 panoramas, and if both images are captured at the same position then the images differ only by a horizontal translation in the image. Once the two images are on a similar capture point, the two images will be merged. In one embodiment, a merging application such as Photosynth™ or HDPhoto™ from Microsoft® Corporation from Redmond, Wash. may be used to merge the images. Once the images are merged, the first stored image may end and the second stored image may begin as the additional illustration 315. In another embodiment, once a common capture point in the first and second moving image is located, the color pixels may be merged toward a midpoint and then the first moving image may hand off to the second moving image to create a smooth additional image 315.

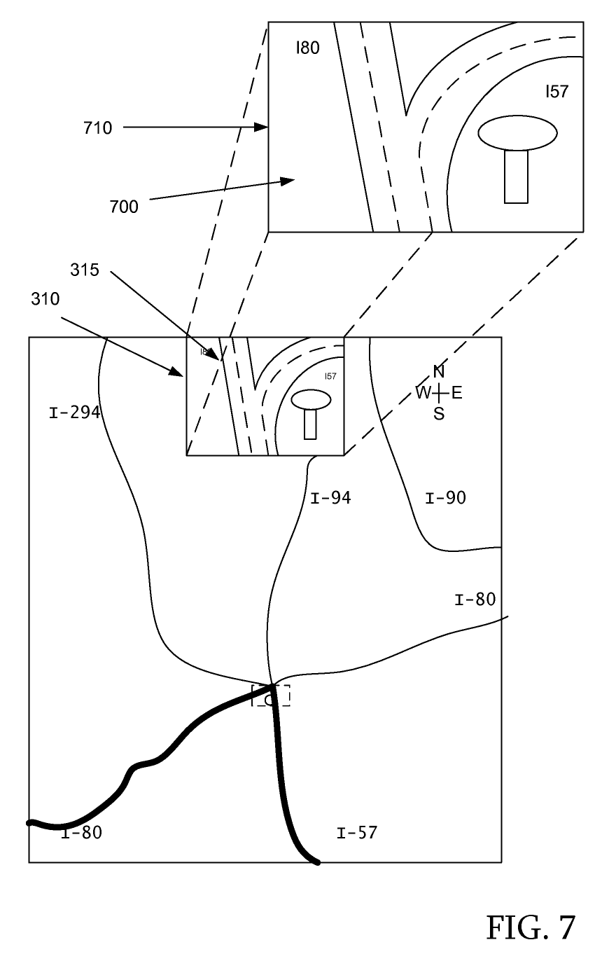

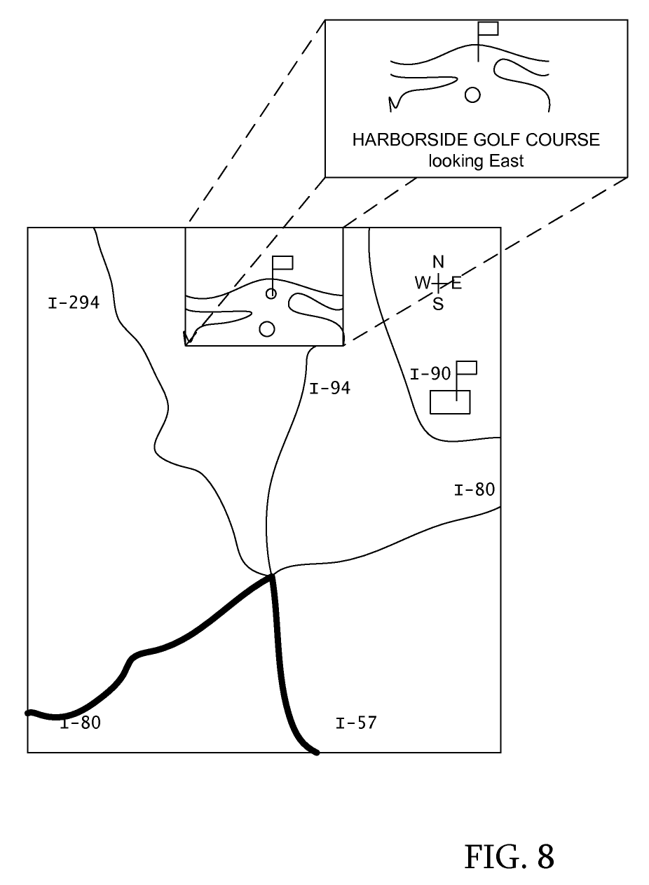

In some embodiment, the points of interest 340 and significant changes 330 may be displayed in an additional fly-off illustration 700 in a split off window 710 that splits off from the separate display window 310 such as illustrated in FIG. 7. In some embodiments, the separate display window 310 may continue to display the additional illustration 315 of the path 320 while the split off window 710 displays the fly-off additional illustration 700. In some embodiments, the additional fly-off illustration 700 is a moving illustration of the points of interest 340 or significant changes 330. In another embodiment such as in FIG. 8, the additional fly-off illustration 700 displays data about the points of interest 340 or significant changes 330.

At block 245, the navigation illustration 300 may be stored in a memory. The navigation illustration, including the addition illustration 315 and any additional fly-off illustrations 715 may then be delivered to any computing device. For example, the navigation illustration 300 may be watched before a hike begins such that the hike will be familiar. In another example, the navigation illustration may be in a car and may help by illustrating significant changes 330 such that tricky turns will not be missed.

In use, the navigation illustration generation application may be used to create improved visualization of paths 320 by focusing on significant changes 330 and points of interest to help guide users. In addition, the variation of speed and altitude may make it easier to visualize directions while creating a compact summary of a path 320.

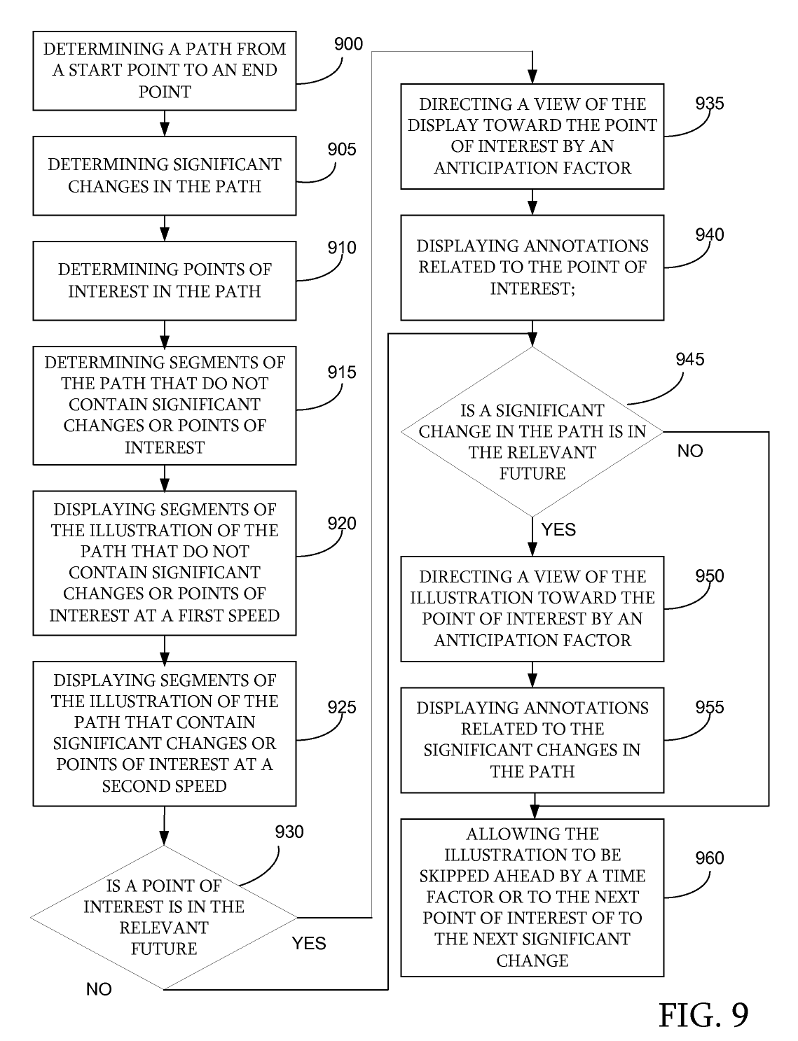

In another embodiment, once a navigation illustration 300 is created, it may be displayed. FIG. 9 illustrates one possible method of displaying a navigational illustration 300. At block 900, a path may be determined from a start point to an end point. As described in block 200, the path 320 may be an additional illustration 315 of a path 320 from a start to an end. The additional illustration 315 may be of road, railroad tracks, airline paths, through building or even through imaginary three dimensional spaces.

At block 905, significant changes 330 in the path 320 may be noted. Significant changes 330 may include turns, lane switches, merges, interchanges, etc. At block 910, points of interest 340 in the path 320 may be determined. Points of interests 340 may include restaurants, gas stations, shopping locations, geographic formations, scenic vistas, billboards, signs, etc. Both the points of interest 340 and significant changes 330 may be coded as existing or may be determined once the navigational illustration 300 is received.

At block 915, segments of the path that do not contain significant changes 330 or points of interest 340 may be determined. Again, these may be coded when the navigation illustration 300 is created or may be created on the fly. At block 920, segments of the illustration of the path 320 that do not contain significant changes 330 or points of interest 340 may be displayed at a first speed. The speed may be faster than the speed to display sections with more points of interest 340 or significant changes 330. In addition, the segments of the illustration of the path 320 that do not contain significant changes 330 or points of interest 340 may be displayed at a first selected altitude. In some embodiments, the altitude is higher than the altitude for segments with more points of interest 340 and significant changes 330 as there is less to see.

At block 925, segments of the illustration of the path 320 that contain significant changes 330 or points of interest 340 may be displayed at a second speed. In addition, segments of the illustration 315 of the path 320 that do contain significant changes 330 or points of interest 340 may be displayed at a second altitude. The user also may be able to mark a spot in the illustration of the path 320 as having a significant change 330 or point of interest 340 such as a landmark of importance to the user. The speed may be slower and the altitude may be lower as there may be more to see. In addition, the speed of the navigational illustration 300 may be controlled by a user. In some embodiments, the altitude and speed may be proportional and in other embodiments the speed of the display is related to the speed of the segment. For example, in FIG. 4, a user may drag a pointer from a first point of interest 340 to an additional point of interest 340 or from a first significant change 330 to additional point of interest 340 or from a point of interest 340 to a significant change 330. In addition, a slider 420 may be used to manipulate the navigational illustration 315. In addition, a user may select any point on the path 320 and the illustration of the path 320 may jump to that point of the path 320.

At block 930, it may be determined if a point of interest 340 is in the relevant future. The relevant future may vary based on the speed of travel and the time needed to prepare to view the point of interest 340. If point of interest 340 is in the relevant future, at block 935, the view of the additional illustration 315 may be directed toward the point of interest 340 by an anticipation factor. If the illustration is being displayed in a car or other vehicle, seats may be adjusted to face the significant change 330 or point of interest 340. In yet another embodiment, the illustration may be displayed using a projector or other visual creating device inside the car and the significant change 330 or point of interest 340 may be displayed on the windows of the vehicle such that users know where and when to look. The display of the significant change 330 or point of interest 340 may gradually fade out or a user may indicate for the display to end. The anticipation factor may be an amount of time and it may vary depending on speed, altitude, etc.

At block 940, annotations 600 related to the point of interest 340 may be displayed. The annotations 600, points of interest 340 and significant changes 330 may be displayed in a separate window 710 split off from a primary display window.

At block 945, it may be determined if a significant changes 330 in the path is in the relevant future. The relevant future may vary based on the speed of travel and the time needed to prepare to view the significant changes 330. If a significant change 330 is in the relevant future, at block 950, the view of the additional illustration 315 of the additional illustration 315 may be directed toward the significant changes 330 by an anticipation factor. The anticipation factor may be an amount of time and it may vary depending on speed, altitude, etc. The significant change 330 may require merging a first illustration and a second illustration as explain in relation to block 240. At block 955, annotations related to the significant changes in the path may be displayed.

At block 960, the play of the navigation may be controlled by skipping from a first point of interest 340 or significant changes 330 to additional points of interest 340 or significant changes 330. In use, a user could view the highlights of a path 320 before taking the path 320. In addition, improved visualization cues in the form of significant changes 330 or points of interest 340 may help travelers find there way.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of creating a navigation illustration comprising
determining a path from a start point to an end point;
obtaining an illustration of the path;
determining significant changes in the path to be stored;
determining points of interest in the path to be stored;
determining segments of the path that do not contain significant changes or points of interest to be stored;
selecting a first speed for displaying the segments of the path that do not contain the significant changes or the points of interest;
selecting a second speed for displaying segments of the illustration of the path that contain the significant changes or the points of interest;
adding annotations that highlight the significant changes to the path or the points of interest;
adjusting the displaying of the segments toward the significant changes or the points of interest in advance by an anticipation factor further comprising rotating or expanding the view toward the significant change; and
storing the navigation illustration in a memory

2. The method of claim 1, wherein the points of interests are selected from a group comprising restaurants, gas stations, shopping locations, geographic formations, scenic vistas, billboards, signs and interchanges and wherein the significant changes are selected from a group comprising turns, merges, lane changes, trail crossings, railroad crossings and dangerous intersections.

3. The method of claim 1, further comprising selecting a first altitude to display the segments of the illustration of the path that do not contain the significant changes or the points of interest and selecting a second altitude to display the segments of the illustration of the path that do contain the significant changes or the points of interest.

4. The method of claim 1, further comprising adding periodic checkpoints.

5. The method of claim 1, further comprising displaying points of interest and the significant changes in a separate window split off from a primary display window.

6. The method of claim 1, further comprising selecting to display the points of interest and the significant changes in the separate window.

7. The method of claim 1, further comprising displaying the path over a traditional map.

8. The method of claim 7, further comprising permitting dragging on map to control speed through the illustration.

9. The method of claim 1, wherein the illustration has a 360 degree panorama view of the path.

10. The method of claim 1, wherein adjusting for the significant changes in the path comprises merging a view from a first segment into a view from a second segment comprising
establishing a common focal point;
adjusting the view toward the common focal point;
merging color pixels from the first segment and the second segment toward a midpoint; and
switching from the first segment to the second segment.

11. The method of claim 1, wherein the path is one selected from a group comprising: inside an office buildings, through an airports, through a hospitals, through a convention center, through a hotel, through an amusement park, through a mall and through a virtual world in a computing application.

12. A method of displaying a navigation illustration comprising:
determining a path from a start point to an end point;
determining significant changes in the path;
determining points of interest in the path;
determining segments of the path that do not contain significant changes or points of interest;
displaying segments of an illustration of the path that do not contain the significant changes or the points of interest at a first speed;
displaying segments of the illustration of the path that contain the significant changes or the points of interest at a second speed;
determining if a point of interest is in a relevant future point;
if point of view is in a relevant future,
directing a view of a separate display toward the point of interest by an anticipation factor;
displaying annotations related to the point of interest;
determining if a significant change in the path is in the relevant future;
if the significant change in the path is in the relevant future,
directing or expanding a view of the separate display toward the point of interest by the anticipation factor;
displaying annotations related to the significant changes in the path;
allowing the illustration to be skipped ahead by a time factor or to an additional point of interest or to an additional significant change

13. The method of claim 12, wherein the points of interests are selected from a group comprising restaurants, gas stations, shopping locations, geographic formations, scenic vistas, billboards, signs and interchanges and wherein the significant changes comprise turns, lane switches, merges, interchanges.

14. The method of claim 12, further comprising displaying segments of the illustration of the path that do not contain the significant changes or the points of interest at a first selected altitude and displaying segments of the illustration of the path that do contain the significant changes or the points of interest at a second altitude.

15. The method of claim 12, further comprising displaying periodic checkpoints on the segments of the illustration of the path that do not contain the significant changes or the points of interest

16. The method of claim 12, further comprising displaying points of interest and the significant changes in a separate window split off from a primary display window.

17. The method of claim 12, wherein the path is displayed over a traditional map.

18. The method of claim 12, further comprising dragging on a map in a primary display window and control speed through the illustration.

19. The method of claim 12, further comprising adjusting for a turn comprises merging a view from a first segment into a view from a second segment comprising
establishing a common focal point;
adjusting the view toward the common focal point;
merging color pixels from the first segment and the second segment toward a midpoint; and
switching from the first segment to the second segment.

20. The method of claim 12, wherein the illustration is of one selected from a group comprising: inside buildings, inside airports, hospitals, hotels, amusement parks, sporting venues, three-dimensional game spaces and malls.
